(19) United States
(12) Patent Application Publication
(10) Pub. No.: US 2005/0246980 A1
(43) Pub. Date: Nov. 10, 2005

(54) Window system

(76) Inventor: Gonzalo Montero, Miami, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(21) Appl. No.: 11/033,245

(22) Filed: Jan. 11, 2005

Related U.S. Application Data
(60) Provisional application No. 60/568,552, filed on May 5, 2004.

(51) Int. Cl. E06B 3/30

(52) U.S. Cl. 52/204.53

(57) ABSTRACT

An impact resistant sash and frame assembly is disclosed including a frame member having a substrate engagement region and a sash engagement region, a sash member operatively engaged to the sash engagement region, the sash member having an exterior portion and a sash member window-supporting region, wherein the exterior portion is curvilinear in a direction away from the sash engagement region.

### CROSS-REFERENCES TO RELATED APPLICATIONS

This application claims the benefit of U.S. Provisional Application Ser. No. 60/568,552, filed on May 5, 2004, entitled WINDOW SYSTEM.

### TECHNICAL FIELD

The present invention relates generally to building structures. More particularly, the present invention relates window and frame assemblies that are resistant to high winds and inclement weather.

### BACKGROUND OF THE INVENTION

Various windows and glass doors have been developed in an effort to avoid the type of structural damage that may result from high winds, as may be experienced in a severe storm, such as a hurricane. Typically, the glass used in wind resistant windows and doors is a laminated glass panel and includes at least one plasticized reinforcing layer positioned adjacent or sandwiched between one or more glass layers.

During a severe storm, the window or door is often subjected to a cycling of pressure where both positive and negative pressures are applied. Under such conditions, a positive pressure indicates that the pressure is greater on the exterior of the window or door, and a negative pressure indicates that the pressure on the interior of the window or door is greater. During the pressure cycling, the plastic film and glass in the glass panel can exert relatively large forces on the window or door sash and frame members.

If the window or glass door fails completely, pressures can be generated internal to the structure that may be sufficiently high to cause damage to the structure. By way of example, a portion of or the entire roof may be blown from the structure. High quality windows and glass doors typically include a wood frame and wood sash and an exterior aluminum cladding material. The wood frame and sash are designed to be aesthetically pleasing, and can be shaped and painted to achieve a variety of designs.

However, the possibility of the wood window or glass door sash and frame assembly failing is increased due to the relative thinness of the shape and materials of the sash. As a result, there are significant problems associated in withstanding strong storm winds, as well as in addressing hurricane standards for building materials, particularly for high-quality wood window frame assemblies and wood glass door assemblies.

One approach to absorb the flexing or movement of the glass panel when subjected to the pressure cycling is to include a relatively large body of sealant material at the interface between the interior wood sash and the glass panel. Unfortunately, the sealant material has a tendency to protrude at the interface between the interior wood sash and the glass panel and does not strengthen the sash.

### SUMMARY OF THE INVENTION

The present invention eliminates the above-mentioned needs for an improved frame and sash assembly for a window by providing a more aerodynamic sash, as well as an enhanced sash and frame engagement.

In accordance with the present invention, there is provided an impact resistant window and frame assembly, including a frame member having a substrate engagement region and a sash engagement region, a sash member operatively engaged to the sash engagement region, the sash member having an exterior portion and a sash member window supporting region, wherein the exterior portion is curvilinear in a direction away from the sash engagement region.

### BRIEF DESCRIPTION OF THE DRAWINGS

FIG. 1 is a top view cross-sectional illustration of the preferred embodiment of the present invention.

FIG. 2 is a top view cross-sectional illustration of the sash of the present invention of FIG. 1.

### DETAILED DESCRIPTION OF THE PREFERRED EMBODIMENT

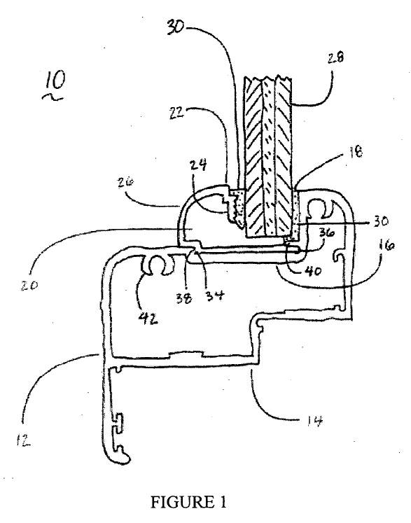

Referring now to FIG. 1, the preferred embodiment of the present invention is illustrated as window assembly 10. Window assembly 10 includes frame member 12, sash member 20, and window 28. Frame member 12 is constructed so as to operationally engage sash member 20, as detailed below.

Frame member 12 preferably incorporates substrate engagement region 14. Substrate engagement region 14 is utilized to secure frame member 12 to the building structure through any one of the manners well known in the art, such as bolts or screws. Frame member 12 further includes sash engagement region 16. Sash engagement region 16 preferably incorporates first sash member engagement lip 38 and second sash member engagement lip 40. First sash member engagement lip 38 and second sash member engagement lip 40 are provided for the operational engagement of sash member 20 to sash engagement region 16 of frame member 12, discussed in detail below.

Additionally, frame member 12 preferably incorporates at least one frame member clip so as to provide a structure that permits frame member 12 to be secured to another frame member (not shown). It is preferred that frame member 12 be constructed from a lightweight metal, such as aluminum, that is sufficiently strong so as to withstand high wind speeds and resulting debris impacts. In accordance with the present invention, frame member 12 and window 28 form a window assembly 10 that is designed to meet or exceed the more stringent building codes in high-velocity hurricane zones, particularly the Dade County building codes (Dade County Protocols PA201-94/PA202-94/PA203-94) that were put into place after the impact of hurricane Andrew. These codes are among the most stringent in the nation for the impact resistance of windows.

Furthermore, frame member 12 includes a window-supporting region 18. Window-supporting region 18 provides a backstop for window 28, assisting in preventing window 28 from falling out of position when secured between window-supporting region 24 of sash member 20 and window-supporting region 18 of frame member 12. It is desirous to have window 28 be sufficiently laminated so as to adequately withstand high speed wind related impacts with debris, such as those incurred during the testing of the aforementioned Dade County Protocols.

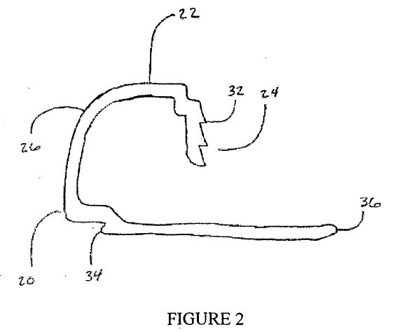

Referring now to FIG. 2, sash member 20 further incorporates an exterior portion 22, oriented to the outside of the building structure. Exterior portion 22 further includes a curvilinear portion 26 opposite of window-supporting region 24. Curvilinear portion 26 functions to impart increased structural strength and improved aerodynamic qualities to sash member 20. The curved structure of curvilinear portion 26 permits a higher degree of flexion than that of a non-curved portion, such as the non-curved portions of sash members of the prior art.

Exterior portion 22 further integrates epoxy engagement ridges 32 in window-supporting region 24. Epoxy engagement ridges 32 permit a more secure engagement between window-supporting region 24, window 28, and epoxy 30 (as illustrated in FIG. 1). As is further illustrated in FIG. 1, epoxy may additionally be utilized between window-supporting region 18 of frame member 12 and window 28.

Preferably, sash member 20 incorporates a first frame member engagement lip 34 and a second frame member engagement lip 36. As is illustrated in FIG. 2, it is preferred that second frame member engagement lip 36 be angled away from a longitudinal axis that passes between first frame member engagement lip 34 and second frame member engagement lip 36. Such angling facilitates a more secure frictional engagement between sash member 20 and frame member 12.

Preferably, sash member 20 and frame member 12 are operationally engaged along sash engagement region 16. First frame member engagement lip 34 of sash member 20 is positioned to engage first sash member engagement lip 38 of frame member 12. Similarly, second frame member engagement lip 36 of sash member 20 is positioned to engage second sash member engagement lip 40 of frame member 12. Preferably, first frame member engagement lip 34, first sash member engagement lip 38, second frame member engagement lip 36, and second sash member engagement lip 40 are slidably engaged, with second frame member engagement lip 36 providing a friction fit between sash member 20 and frame member 12.

Although only a few exemplary embodiments of the present invention have been described in detail above, those skilled in the art will readily appreciate that numerous modifications to the exemplary embodiments are possible without materially departing from the novel teachings and advantages of this invention. Accordingly, all such modifications are intended to be included within the scope of this invention as defined in the appended claims.

1. An impact resistant sash and frame assembly, comprising:
a frame member having a substrate engagement region and a sash engagement region;
a sash member operatively engaged to the sash engagement region, the sash member having an exterior portion and a sash member window-supporting region;
wherein the exterior portion is curvilinear in a direction away from the sash engagement region.

2. The sash and frame assembly of claim 1 wherein the frame member further includes at least one sash engagement lip.

3. The sash and frame assembly of claim 2 wherein the sash member includes at least one frame engagement lip.

4. The sash and frame assembly of claim 3 wherein the at least one frame engagement lip is angled.

5. The sash and frame assembly of claim 2 wherein the at least one sash engagement lip and the at least one frame engagement lip are operationally engaged.

6. The sash and frame assembly of claim 1 wherein the sash member window-supporting region further includes epoxy engagement ridges.

7. The sash and frame assembly of claim 6 wherein the frame member further includes a frame member window-supporting region.

8. The sash and frame assembly of claim 7 wherein a window is positioned between the sash member window-supporting region and the frame member window-supporting region.

9. The sash and frame assembly of claim 8 wherein the window is further secured between the sash member window-supporting region and the frame member window-supporting region by epoxy.

10. The sash and frame assembly of claim 1 wherein the frame member is constructed of metal.

11. The sash and frame assembly of claim 10 wherein the frame member is constructed of aluminum.

12. The sash and frame assembly of claim 1 wherein the sash member window-supporting region supports a window.

13. The sash and frame assembly of claim 1 wherein the window is laminated.
